(19) United States
(12) Patent Application Publication
(10) Pub. No.: US 2017/0161677 A1
(43) Pub. Date: Jun. 8, 2017

(54) SYSTEM AND METHOD FOR SALES SUPPORT

(71) Applicant: OPTiM Corporation, Saga (JP)

(72) Inventor: Shunji SUGAYA, Tokyo (JP)

(21) Appl. No.: 15/138,332

(22) Filed: Apr. 26, 2016

(30) Foreign Application Priority Data
Dec. 8, 2015 (JP) 2015-239602

(51) Int. Cl. G06Q 10/08; G06Q 30/06; G06Q 20/40

(52) U.S. Cl. CPC G06Q 10/0833; G06Q 20/407; G06Q 30/0619

(57) ABSTRACT

The time from when the sale and purchase are made to when the product is delivered is to be reduced. The system for sales support includes: a memory unit that stores management information associated with information on a product before the sale and purchase are made with an deliverable date when a seller of the product is to deliver the product to a courier; a notifying-to-courier unit that notifies a courier of the deliverable date if the sale and purchase are made; a receiving unit that receives a response to the notification from the courier; and a notifying-to-seller unit that notifies the seller of the product of the received response.

### CROSS REFERENCE TO RELATED APPLICATIONS

This application claims priority to Japanese Patent Application No. 2015-239602 filed on Dec. 8, 2015, the entire contents of which are incorporated by reference herein.

### TECHNICAL FIELD

The present invention relates to a technology to support the sale of products, etc.

### BACKGROUND ART

Internet shopping to sell products through a network such as the Internet and to deliver the ordered products to the purchasers has been widespread. Patent Document 1 discloses the technology by which an orderer orders a product from the orderer's terminal through a plurality of distributors over a network and collectively instructs the distributors to collect and deliver all the ordered products to reduce clerical burden for the distributors.

### CITATION LIST

### Patent Literature

Patent Document 1: JP 2002-56309 A

### SUMMARY OF INVENTION

Conventional sales support systems often require time from when the sale and purchase are made to when the product is delivered because the shipment date is not determined until the sale and purchase of the products are made.

Therefore, an objective of the present invention is to provide a system to reduce time from when the sale and purchase are made to when the product is delivered.

A system for sales support according to the first aspect of the present invention includes:

a memory unit that stores management information associated with information on a product before the sale and purchase are made with a deliverable date when a seller of the product can deliver the product to a courier;

a notifying-to-courier unit that notifies a courier of the deliverable date if the sale and purchase are made;

a receiving unit that receives a response to the notification from the courier; and

a notifying-to-seller unit that notifies the seller of the product of the received response.

According to the system for sales support, the courier can be notified of a deliverable date that was registered before the sale and purchase are made, if the sale and purchase are made, and the seller of the product whose sale and purchase have been made can be notified of a response to the deliverable date from the courier.

The system for sales support may further include a selection unit that selects a desired date from a plurality of deliverable dates by a courier that has received the notification from the notifying-to-courier unit. The notifying-to-seller unit may notify the seller of the product of the selected date.

The management information is further associated with a deliverable time when the seller of the product can deliver the product to the courier. The notifying-to-courier unit may notify the courier of the deliverable time if the sale and purchase are made.

The system for sales support may further include a cancellation unit that cancels the received response.

The memory unit may store the management information if the sale-and-purchase probability calculated based on a sale price of the product is a predetermined threshold or more.

The system for sales support may further include a presentation unit that presents the sale-and-purchase probability calculated based on a sale price of the product to the seller.

According to the present invention, the time from when the sale and purchase are made to when the product is delivered can be reduced.

### BRIEF DESCRIPTION OF DRAWINGS

FIG. 1 shows a schematic diagram of the whole environment including the system for sales support according to this embodiment.

FIG. 2 shows an example of the action of the whole environment including the system for sales support.

FIG. 3 shows an example of the configuration of the system for sales support.

FIG. 4 shows an example of the management table.

FIG. 5 shows a flow chart illustrating one example of the product registration process.

FIG. 6 shows a flow chart illustrating one example of the product delivery process.

### DESCRIPTION OF EMBODIMENTS

Embodiments of the present invention will be described below with reference to the attached drawings. However, this is illustrative only, and the technological scope of the present invention is not limited thereto.

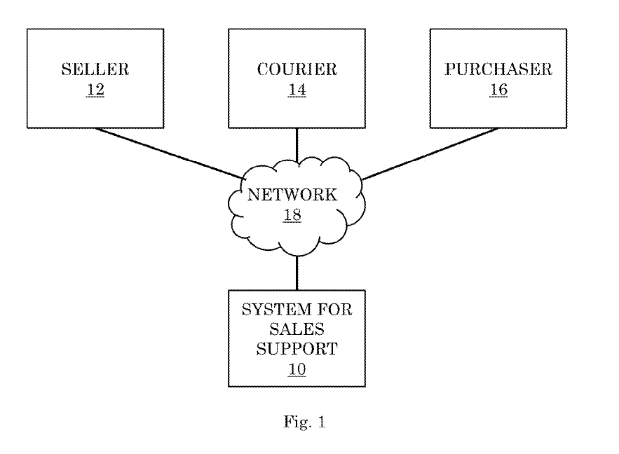

FIG. 1 shows a schematic diagram of the whole environment including the system for sales support 10 according to this embodiment.

The system for sales support 10 may be a server with a capability of interactively transmitting and receiving data to and from the respective terminals of the seller 12, the courier 14, and the purchaser 16 through a network 18. The system for sales support 10 may be achieved by a single server or by a plurality of servers with a different composition. The network 18 may be the Internet, a LAN, or the combination of these. The respective terminals of the seller 12, the courier 14, and the purchaser 16 form the whole environment through the network 18.

The terminal of a seller 12 is used by the seller 12 of a product. Examples of the terminal of a seller 12 include a PC and a smart phone. The seller 12 may be an individual or a company. Examples of the seller 12 include an operator of WEB shopping and a seller of Internet auction.

The terminal of a courier 14 is used by the courier 14 of a product. Examples of the terminal of a courier 14 include a business server, a PC, and a smart phone. Examples of the courier 14 include a mailing company, a courier company, and a carrying company.

The terminal of a purchaser 16 is used by the purchaser 16 of a product. Examples of the terminal of a purchaser 16 include a PC and a smart phone. The purchaser 16 may be an individual or a company.

The seller 12, the courier 14, and the purchaser 16 in the explanation of the embodiment may be referred to as their respective terminals.

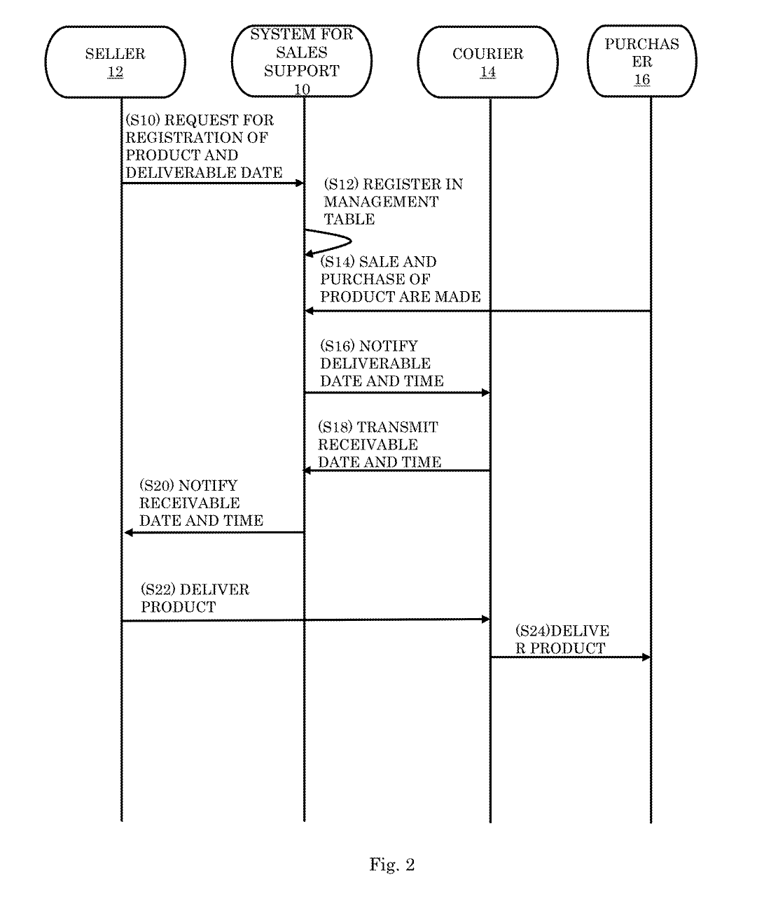

FIG. 2 shows an example of the action of the whole environment including the system for sales support 10.

### S10

The seller 12 transmits a registration request including information on the product before the sale and purchase are made and a date and time (deliverable date and time) when the seller 12 can deliver the product to the courier 14, if the sale and purchase are made to the system for sales support 10. The product before the sale and purchase are made is going to be sold or has not been sold yet since the start of the sales.

The registration request may include a plurality of deliverable dates and times. In the case where the courier 14 visits the seller 12 to receive a product, the deliverable date and time may be when the seller 12 is at home or at the office. In the case where the seller 12 brings a product to the courier 14, the deliverable date and time may be when the seller 12 can bring a product to the courier 14.

The information on a product may include the name, the sale price, the feature, the size, and the weight. The registration request may further include the name, the address, and the phone number of the seller 12.

### S12

If receiving the registration request, the system for sales support 10 associates and registers information on the product before the sale and purchase are made with a deliverable date and time of this product, which are included in the registration request, in the management table 100. Details of the management table 100 are to be described later.

### S14

If detecting a product whose sale and purchase have been made between the seller and the purchaser 16 from the products in the management table 100, the system for sales support 10 proceeds to the following S16.

### S16

The system for sales support 10 notifies the courier 14 of the deliverable date and time associated with the product whose sale and purchase have been made in the management table 100. In other words, the system for sales support 10 notifies the courier 14 of a deliverable date and time associated with the product if the sale and purchase of the product are made.

### S18

If receiving the deliverable date and time from the system for sales support 10, the courier 14 selects a receivable date and time when the courier 14 can receive the product from one or more of the received deliverable dates and times. The courier 14 may select a plurality of receivable dates and times. If the courier 14 cannot receive the product on any of the deliverable dates and times, the courier 14 may not select a receivable date and time. The courier 14 transmits the selected receivable date and time to the system for sales support 10.

In the case where the courier 14 visits the seller 12 to collect the product, the receivable date and time may be when the courier 14 can visit the seller 12. In the case where the seller 12 brings the product to the courier 14, the receivable date and time may be when the seller 12 can bring a product to the courier 14.

### S20

If receiving the receivable date and time from the courier 14, the system for sales support 10 notifies the seller 12 of the product whose sale and purchase have been made that has been detected in S14 of the receivable date and time.

### S22

The seller 12 delivers the product whose sale and purchase have been made to the courier 14 on the receivable date and time. The courier 14 may visit the seller 12 to receive the product whose sale and purchase have been made on the receivable date and time. Alternatively, the seller 12 may bring the product whose sale and purchase have been made to the courier 14. The product whose sale and purchase have been made may be received or brought in a different way.

### S24

The courier 14 delivers the product whose sale and purchase have been made received from the seller 12 to the purchaser 16.

As described above, the system for sales support 10 notifies the courier 14 of the deliverable date and time of the seller 12 that is previously registered immediately after the sale and purchase are made. This enables the time from when the sale and purchase are made to when the product is delivered to be reduced.

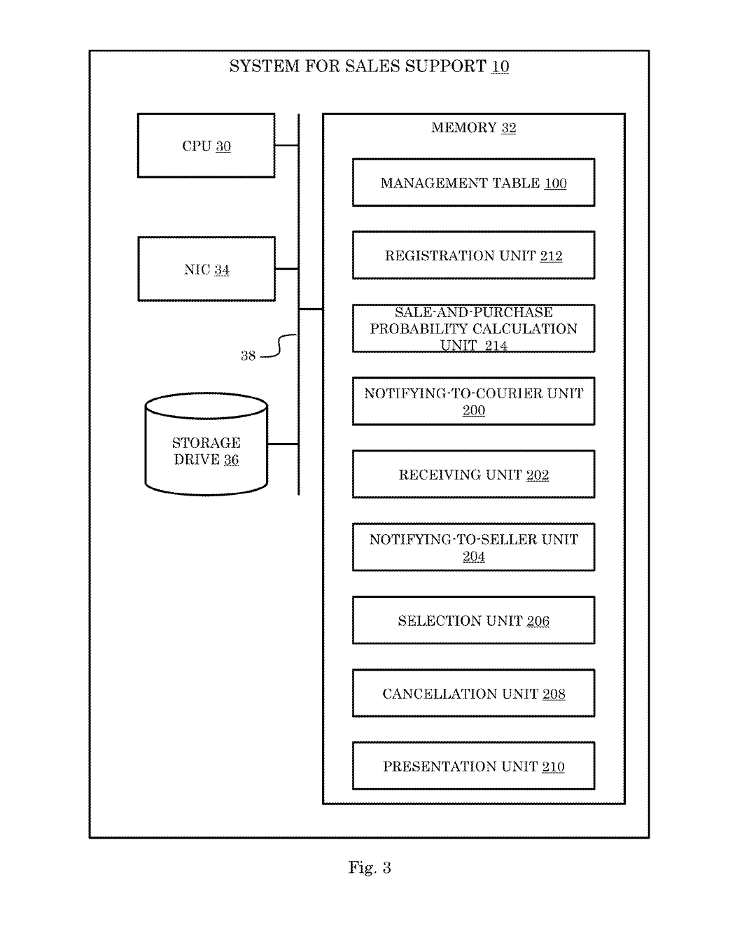

FIG. 3 shows an example of the configuration of the system for sales support 10.

The system for sales support 10 may include a central processing unit (hereinafter referred to as “CPU”) 30, a memory 32, a network interface card (hereinafter referred to as “NIC”) 34, and a storage drive 36 as the physical devices. These components may be connected through an internal bus 38.

The memory 32 is a device with a capability of data storage. The memory 32 may store a program, data, etc. to achieve the functions of the system for sales support 10. An example of the memory 32 includes a dynamic random access memory (hereinafter referred to as “DRAM”).

The CPU 30 is a device with a capability of logical operation. The CPU 30 may achieve the functions of the system for sales support 10 by executing programs read out from the memory 32.

The NIC 34 is an I/F device to connect the system for sales support 10 with the network 18. An example of the NIC 34 includes an Ethernet® card.

The storage drive 36 is a device with a capability of a large amount of data storage. Examples of the storage drive 36 include a hard disk drive (hereinafter referred to as “HDD”) and a solid state drive (hereinafter referred to as “SSD”).

The system for sales support 10 may have a management table 100 as information. The management table 100 may be stored in the storage drive 36 or the memory 32, or the both. The management table 100 will be described below.

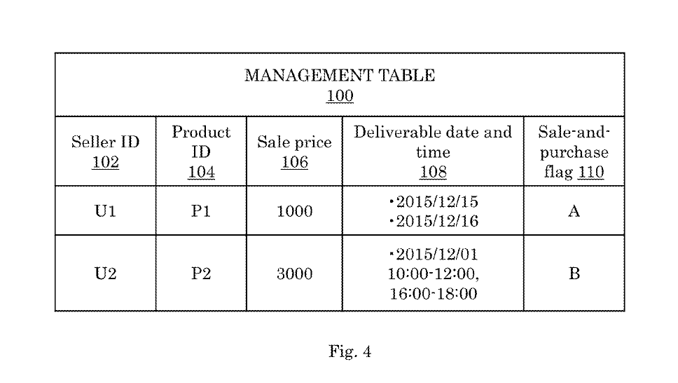

FIG. 4 shows an example of the management table 100.

The management table 100 manages the deliverable date and time when the seller 12 can deliver the product whose sale and purchase have been made.

The management table 100 may have a seller ID 102, a product ID 104, a sale price 106, a deliverable date and time 108, and a sale-and-purchase flag 110 as item values.

The seller ID 102 is the identifier of a seller 12. The seller ID 102 may be the name, the phone number, the log in ID, etc., of the seller 12.

The product ID 104 is the identifier of a product that a seller 12 with the seller ID 102 sells. The product ID 104 may be the name, the product number, etc., of a product.

The sale price 106 is of a product with the product ID 104. The sale price 106 may be determined by a seller 12 with the seller ID 102.

The deliverable date and time 108 is when a seller 12 with the seller ID 102 can deliver a product with the product ID 104 to the courier 14. The deliverable date and time 108 is not limited to the combination of a date and a time zone and may be only a date or a time zone. The deliverable date and time 108 may have a plurality of dates and times.

The sale-and-purchase flag 110 shows whether or not the sale and purchase of a product with the product ID 104 are made. In FIG. 4, the sale-and-purchase flags 110 “B” and “A” represent before and after the sale and purchase are made, respectively. As long as it can distinguish whether or not the sale and purchase of a product are made, the sale-and-purchase flag may not be expressed by “A” and “B” and may be expressed by the others.

If the sale-and-purchase flag 110 is “B” and if the deliverable date and time 108 is in the past, the system for sales support 10 may delete the deliverable date and time 108. Alternatively, the system for sales support 10 may request a seller 12 with the seller ID 102 to reregister the deliverable date and time.

It returns to the explanation of FIG. 3.

The system for sales support 10 may include a registration unit 212, a sale-and-purchase probability calculation unit 214, a notifying-to-courier unit 200, a receiving unit 202, a notifying-to-seller unit 204, a selection unit 206, a cancellation unit 208, and a presentation unit 210 as the functions. The CPU 30 may achieve these functions by executing programs stored in the storage drive 36 or the memory 32, or the both.

The registration unit 212 receives the registration request including information (e.g., product ID, sale price) on a product before the sale and purchase are made and a deliverable date and time of the product from the seller 12. The registration unit 212 associates and registers the seller ID of the seller who has transmitted the registration request, information on the product, and the deliverable date and time which are included in the received registration request in the management table 100.

The sale-and-purchase probability calculation unit 214 calculates the sale-and-purchase probability of the product based on the sale price of the product included in the registration request that the registration unit 212 has received. For example, the sale-and-purchase probability calculation unit 214 may compare the average sale price in the product field with the sale price included in the registration request to calculate the sale-and-purchase probability. The sale-and-purchase probability calculation unit 214 may calculate the average sale price in the product field based on the past sale prices, the sales prices on WEB, etc.

Only if the sale-and-purchase probability is a predetermined threshold or more, the registration unit 212 may register the content of the registration request in the management table 100. In other words, if the sale-and-purchase probability is less than a predetermined threshold, the registration unit 212 may not register the content of the registration request in the management table 100. This is because the sale and purchase of the product with a low sale-and-purchase probability is unlikely to be made by the deliverable date and time included in the registration request. If the sale-and-purchase probability is a predetermined threshold or more, the memory unit may store the management table 100.

The presentation unit 210 presents various types of information to the seller 12. The presentation unit 210 also presents the sale-and-purchase probability of the product to the seller 12. If the sale-and-purchase probability is less than a predetermined threshold, the presentation unit 210 may present the sale price when the sale-and-purchase probability is a threshold or more to the seller 12. This enables the seller 12 to know the appropriate sale price of the product.

If detecting the product with the sale-and-purchase flag “A” (i.e. product whose the sale and purchase are made) from the management table 100, the notifying-to-courier unit 200 notifies the courier 14 of a deliverable date and time 108 associated with the product (with the product ID 104) whose sale and purchase have been made.

The selection unit 206 selects (answers) a desired date from a plurality of deliverable dates and times 108 by a courier that has received the notification from the notifying-to-courier unit 200. The receiving unit 202 receives the response including the receivable date and time of the courier 14 selected from the deliverable dates and times that the notifying-to-courier unit 200 has notified, from the courier 14. The notifying-to-seller unit 204 notifies the seller 12 (with the seller ID 102) of the product (with the product ID 104) whose sale and purchase have been made of the receivable date and time that the receiving unit 202 has received.

This enables the seller 12 to know the receivable date and time suitable for the courier 14 immediately after the sale and purchase are made. This receivable date and time is also suitable for the seller 12 because it is any one of the deliverable dates and times of the seller 12. Therefore, the seller 12 can smoothly deliver the product whose sale and purchase have been made to the courier 14 on this receivable date and time. This enables the time from when the sale and purchase are made to when the product is delivered to be reduced.

The cancellation unit 208 may receive a cancel or change request for the receivable date and time of the product whose sale and purchase have been made that the courier 14 has notified to the seller 12, from the seller 12. This enables the seller 12 to cancel or change a once determined-receivable date and time. If receiving this cancel or change request, the cancellation unit 208 may notify the courier 14 of this request. This enables the courier 14 to know the cancel or the change of the receivable date and time.

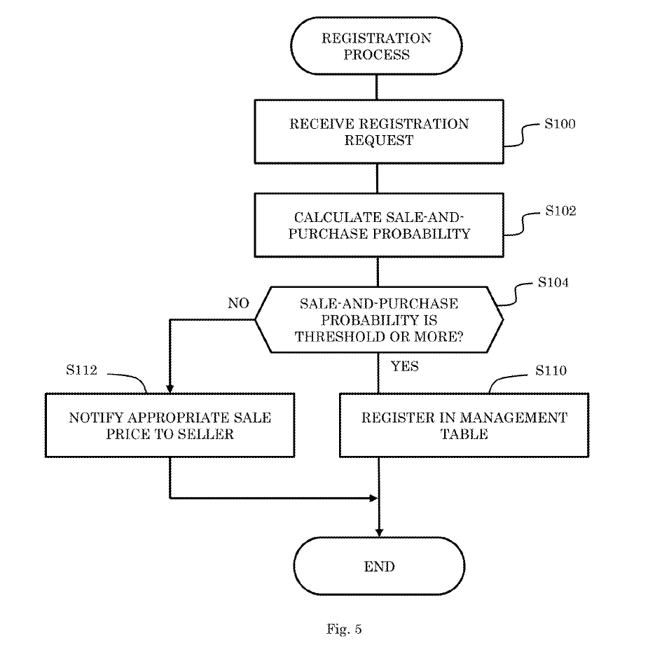

FIG. 5 shows a flow chart illustrating one example of the product registration process.

### S100

If receiving the registration request from the seller 12, the registration unit 212 proceeds to S102.

### S102

The sale-and-purchase probability calculation unit 214 calculates the sale-and-purchase probability of the product based on the sale price of the product included in the registration request as described above.

### S104

The registration unit 212 judges whether or not the sale-and-purchase probability is a predetermined threshold or more. If the judgment result is true (YES), the registration unit 212 proceeds to S110, but if false (NO), to S112

### S110

If the judgment result of S104 is true (YES), the registration unit 212 associates and registers information on the product with the deliverable date and time which are included in the received registration request in the management table 100. This process is then ended.

### S112

If the judgment result of S104 is false (NO), the presentation unit 210 notifies the seller 12 of the sale price when the sale-and-purchase probability is a threshold or more (appropriate sale price) or presents this price to the seller. This enables the seller 12 to know the appropriate sale price of the product. This process is then ended.

The above-mentioned processes enable the seller 12 to register the deliverable date and time of the product in the management table 100 of the system for sales support 10. In the management table 100 of the system for sales support 10, the deliverable date and time of the product whose sale and purchase are comparatively likely to be made is registered.

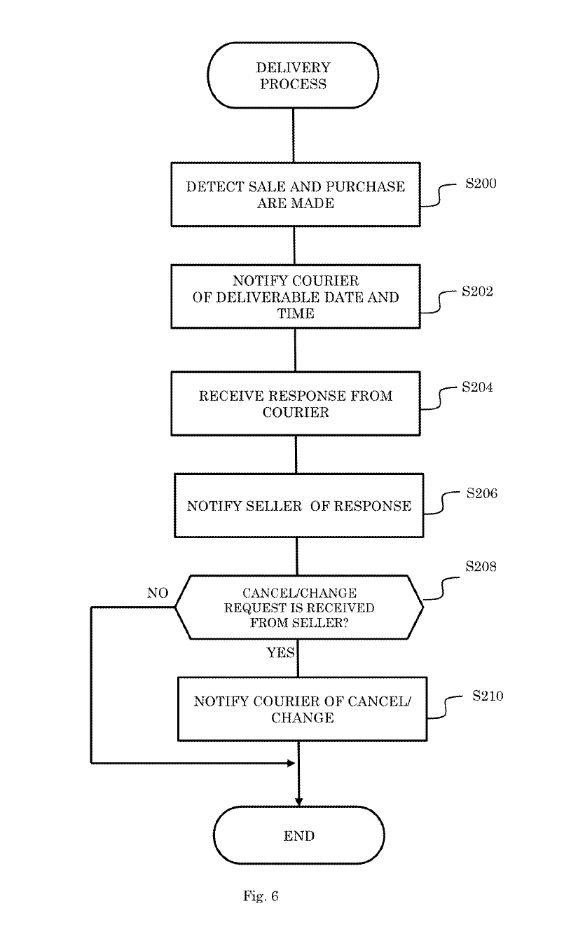

FIG. 6 shows a flow chart illustrating one example of the product delivery process.

### S200

If detecting a product whose sale and purchase have been made between the seller and the purchaser 16 from the products registered in the management table 100, the notifying-to-courier unit 200 proceeds to S202.

### S202

The notifying-to-courier unit 200 notifies the courier 14 of a deliverable date and time 108 associated with the product (with the product ID 104) whose sale and purchase have been made in the management table 100 and proceeds to S204.

### S204

The selection unit 206 selects a receivable date and time from the deliverable dates and times that the courier 14 has notified in S202. If receiving the response that the selection unit 206 has selected, the receiving unit 202 proceeds to S206.

### S206

The notifying-to-seller unit 204 notifies the seller 12 (with the seller ID 102) of the product (with the product ID 104) whose sale and purchase have been made of the receivable date and time received from the courier 14 in S204 and proceeds to S206.

### S208

If receiving the cancel or the change request for the receivable date and time of the product whose sale and purchase have been made from the seller 12 (YES), the cancellation unit 208 proceeds to S210 but, if not (NO), ends the process.

### S210

The cancellation unit 208 notifies the courier 14 of the cancel or the change of the receivable date and time and ends this process.

The above-mentioned processes enable the seller 12 to know the receivable date and time of the courier 14 immediately after the sale and purchase of the product are made. This enables the time from when the sale and purchase are made to when the product is delivered to be reduced.

The above-mentioned processes also enable the courier 14 to know the cancel or the change of the receivable date and time that the seller 12 has made. Therefore, the courier 14 less often uselessly visits the seller 12.

The embodiments of the present invention are described above. However, the present invention is not limited to the above-mentioned embodiments. The effect described in the embodiments of the present invention is only the most preferable effect produced from the present invention. The effects of the present invention are not limited to that described in the embodiments of the present invention.

### REFERENCE SIGNS LIST

10 System for sales support
12 Seller
14 Courier
16 Purchaser
100 Management table
200 Notifying-to-courier unit
202 Receiving unit
204 Notifying-to-seller unit
206 Selection unit
208 Cancellation unit
210 Presentation unit
212 Registration unit
214 Sale-and-purchase probability calculation unit

What is claimed is:

1. A system for sales support, comprising:
a memory unit that stores management information associated with information on a product before the sale and purchase are made with an deliverable date when a seller of the product is to deliver the product to a courier;
a notifying-to-courier unit that notifies a courier of the deliverable date if the sale and purchase are made;
a receiving unit that receives a response to the notification from the courier; and
a notifying-to-seller unit that notifies the seller of the product of the received response.

2. The system for sales support according to claim 1, further comprising a selection unit that selects a desired date from a plurality of deliverable dates by a courier that has received the notification from the notifying-to-courier unit, wherein the notifying-to-seller unit notifies the seller of the product of the selected date.

3. The system for sales support according to claim 1, wherein the management information is further associated with a deliverable time when the seller of the product can deliver the product to the courier, and the notifying-to-courier unit notifies the courier of the deliverable time if the sale and purchase are made.

4. The system for sales support according to claim 1, further comprising a cancellation unit that cancels the received response.

5. The system for sales support according to claim 1, wherein the memory unit stores the management information if the sale-and-purchase probability calculated based on a sale price of the product is a predetermined threshold or more.

6. The system for sales support according to claim 1, further comprising a presentation unit that presents the sale-and-purchase probability calculated based on the sale price of the product to the seller.

7. A method for sales support, comprising the steps of
storing management information associated with information on a product before the sale and purchase are made with a deliverable date when a seller of the product can deliver the product to a courier;
notifying a courier of the deliverable date if the sale and purchase are made;
receiving a response to the notification from the courier; and
notifying the seller of the product of the received response.
